(19) United States
(12) Patent Application Publication
(10) Pub. No.: US 2021/0150700 A1
(43) Pub. Date: May 20, 2021

(54) DEFECT DETECTION DEVICE AND METHOD

(71) Applicant: UnitX, Inc., San Jose, CA (US)

(72) Inventor: Kedao Wang, San Jose, CA (US)

(73) Assignee: UnitX, Inc., San Jose, CA (US)

(21) Appl. No.: 16/953,959

(22) Filed: Nov. 20, 2020

(30) Foreign Application Priority Data
Nov. 20, 2019 (CN) 201911137321.5

(51) Int. Cl. G06T 7/00; G06K 9/62; G06N 7/00; G01N 21/88

(52) U.S. Cl. CPC G06T 7/0006; G06K 9/6277; G01N 2021/8887; G01N 21/8851; G06T 2207/20084; G06N 7/005

(57) ABSTRACT

A defect detection device includes an image capturing component for capturing one or more images of an object to be inspected; a motion component configured to grasp or manipulate the object or the image capturing component; and a computing device configured to perform a defect detection method, including determining a plurality of first image capturing poses of the object to be inspected; determining a first defect probability for each particular first image capturing pose; establishing a probability matrix based on the first defect probabilities; subdividing the probability matrix into a plurality of submatrices according to preset dimensions for each submatrix; determining a second defect probability for each of the plurality of submatrices; setting a maximum value of the second defect probabilities as a third defect probability of the object to be inspected; and comparing the third defect probability to a threshold to determine whether the object is defective.

### CROSS-REFERENCE TO RELATED APPLICATIONS

This application claims priority to Chinese Patent Application No. 201911137321.5, filed on Nov. 20, 2019. The disclosure of the above application is hereby incorporated by reference in its entirety.

### FIELD

The present disclosure relates to the field of computer vision, and in particular to a defect detection device and method.

### BACKGROUND

At present, defect detection of objects (such as various types of metal casting parts) is mainly based on traditional vision inspection, for example, by detecting defects through template matching or manually engineered features. The hardware used in this method is often non-standardized. This means, to grasp capture objects of different geometric shapes and capture images of different defects, it is necessary to customize tools, grippers, image capturing, and lighting. Sometimes, the method requires customization of the overall mechanical structure of the detection device. Customization, as a result of non-standard hardware, severely limits the scopes of the traditional method's application and makes it hard to work with many types of objects.

Defect detection based on traditional vision is extremely dependent on the work of software engineers, who engineer the templates or features. Whenever a new defect appears, a software engineer needs to manually update the template or feature, which does not automatically adapt to the new defect. When using manually written templates or features to detect defects, it is difficult to detect random defects (such as scratches) or correctly identify complex surfaces of material (such as surfaces of machined metals), leading to false acceptance and false rejection, lowering the accuracy of detection.

In addition, defect detection based on traditional vision inspection uses a fixed trajectory in capturing images of the object. If the aim is to inspect the object from all possible angles, images must be captured many times, with much time spent and low efficiency. When this method tries to confirm defects based on the many images captured, it judges by looking at each image individually and tends to false rejection or false acceptance.

### BACKGROUND

In view of this, the present disclosure proposes technical solution for defect detection.

One aspect of the present disclosure provides a defect detection device. The said device comprises a motion component, an image capturing component, and a computing component. The computing component is motion and image capturing components. The motion component is used for grasping and/or placing the object to be inspected, and/or moving the said image capturing component. The said image capturing component is used for capturing the image of the object. The said computing component includes: (1) path planning module: determines multiple “1st image capturing poses” of the object to be inspected. These poses are set according to all possible image capturing poses of the test object and a preset “1st sample rate; determines the “1st defect probabilities” at each “1st image capturing pose,” based on the said image capturing component's “1st “detected image” captured at each “1st image capturing pose”; establishes a probability matrix according to the said “1st defect probabilities,” as well as preset defect probabilities for all other possible image capturing poses, excluding the ones with images captured; splits the probability matrix into multiple submatrices according to preset dimensions for each submatrix, and determines the “2nd defect probabilities” of the area that each submatrix corresponds to; (2) decision module: sets the maximum value of the “2nd defect probabilities” as the “3rd defect probability” of the object to be inspected; when the “3rd defect probability” is greater than or equal to the “defect probability threshold”, the object to be inspected is judged to be defective, otherwise not defective.

In an embodiment, the path planning module is also used to: determine whether each “2nd defect probability” satisfies the confidence criterion, where the said confidence criterion is that if the “2nd defect probability” is less than or equal to a preset “1st confidence threshold,” or, the “2nd defect probability” is greater than or equal to a preset “2nd confidence threshold,” and where the said “1st confidence threshold” is less than the “2nd confidence threshold”; when each “2nd defect probability” satisfies the confidence criterion, go straight into the decision module to determine defects; when there exists at least one “2nd defect probability” that does not satisfy the confidence criterion, in the partitioned area that corresponds to the “2nd defect probability” which does not satisfy the confidence criterion, determine the “2nd image capturing pose” according to a preset “2nd sampling rate,” determine the “4th defect probability” of each “2nd image capturing pose” according to the “2nd detected image” at each pose; in the submatrix that corresponds to the said partitioned area, replace the preset defect probabilities with the “4th defect probabilities,” to re-determine the “2nd defect probabilities” of this area; repeat the decision process for each “2nd defect probability,” until each “2nd defect probability” satisfies the confidence criterion.

In another embodiment, the method determines the “2nd defect probabilities” through a convolutional neural network, comprising: determining the convolution kernel and stride length of the convolutional neural network, according to the preset size of the submatrix; performing a convolution operation on the probability matrix through the convolution network, according to the convolution kernel and the step size, to obtain the “2nd defect probability” of each partitioned area of the object to be inspected.

In another embodiment, the size of the said submatrix is determined by the average maximum sample interval for consecutive imaging capable of observing defects and a preset imaging resolution. The parameters of the convolutional neural network are determined according to a probability distribution, preferably a Gaussian distribution.

In another embodiment, the said set of “2nd image capturing poses” does not include the “1st image capturing poses.”

In an embodiment, the path planning module is also used to: determine all available image capturing poses of the object to be inspected according to the preset imaging resolution and the geometric shape of the object to be inspected; determine image capturing pose's image capturing angle according to the preset angular resolution.

In an embodiment, the path planning module is also used to: obtain at least one “1st detected image” from each “1st image capturing pose” based on each pose's image capturing angle, and determine the “1st defect probability” of each “1st image capturing pose” according to at least one of the said “1st detected images,” and/or obtain at least one “2nd detected image” from each “2nd image capturing pose” based on each pose's image capturing angle, and determine the “4th defect probability” of each “2nd image capturing pose” according to at least one of the said “2nd detected images.”

In another embodiment, the method determines the “1st defect probabilities” and/or the “4th defect probabilities” through a decision network, comprising: feeding the “1st detection images” and/or the “2nd detection images” into the decision network for computing, to obtain the “1st defect probabilities” and/or the “4th defect probabilities”.

In another embodiment, the said motion component comprises a robot or a manipulator, and the imaging capturing system comprises a camera and a light source.

In another embodiment, the end of the robot or manipulator is a gripper and/or the said image capturing component.

In another embodiment, the said multiple submatrices are partially overlapping.

According to another aspect of the present disclosure, a defect detection method is provided, which comprises: path planning: determines multiple “1st image capturing poses” of the object to be inspected. These poses are set according to all possible image capturing poses of the test object and a preset “1st sampling rate”; determines the “1st defect probabilities” at each “1st image capturing pose,” based on theist “detected images” captured at the said each “1st image capturing pose”; establishes a probability matrix according to the said “1st defect probabilities,” as well as preset defect probabilities for all other possible image capturing poses, excluding the ones with images captured; splits the probability matrix into multiple submatrices according to preset dimensions for each submatrix, and determines the “2nd defect probabilities” of the area that each submatrix corresponds to; decision step: sets the maximum value of the “2nd defect probabilities” as the “3rd defect probability”; when the “3rd defect probability” is greater than or equal to the “defect probability threshold”, the object to be inspected is judged to be defective, otherwise not defective.

In another embodiment, the path planning step further is configured to: determine whether each “2nd defect probability” satisfies the confidence criterion, where the said confidence criterion is that if the “2nd defect probability” is less than or equal to a preset “1st confidence threshold,” or, the “2nd defect probability” is greater than or equal to a preset “2nd confidence threshold,” and where the said “1st confidence threshold” is less than the “2nd confidence threshold”; when each “2nd defect probability” satisfies the confidence criterion, go straight into the decision step; when there exists at least one “2nd defect probability” that does not satisfy the confidence criterion, in the partitioned areas that correspond to those “2nd defect probabilities” which do not satisfy the confidence criterion, set “2nd image capturing poses” according to a preset “2nd sampling rate,” determine the “4th defect probability” of each “2nd image capturing pose” according to the “2nd detected image” at each pose; in the submatrix that corresponds to the said partitioned area, replace the preset defect probabilities with the “4th defect probabilities,” to re-determine the “2nd defect probabilities” of this area; repeat the decision process for each “2nd defect probability,” until each “2nd defect probability” satisfies the confidence criterion.

According to the embodiments of the present disclosure, it is possible to use the path planning module of the computing component to determine multiple image capturing poses of the object to be inspected object, according to all possible image positions and sampling rates; then use the motion component to grasp and/or place the said object, and/or adjust the image capturing component, to obtain multiple images of the said object; based on these detected images, the path planning module determines the defect probabilities of multiple image capturing poses and establishes a probability matrix, then determines the defect probabilities of each partitioned area; determines the maximum of these partitioned areas' defect probabilities through the decision module of the computing component, and determines the result of defect detection of the said object. This defect detection method sets image capturing poses based on all possible image capturing poses and the sampling rate, and uses the correlation of the image capturing poses to determine the detection result, thereby improving both efficiency and accuracy of detection, and reduce false rejection and false acceptance.

### BRIEF DESCRIPTION OF THE DRAWINGS

The following gives detailed description of the specific embodiments of the present invention, accompanied by diagrams to clarify the technical solutions of the present invention and its benefits.

FIG. 1 shows a system diagram of a defect detection device according to an embodiment of the present disclosure.

FIG. 2 shows a flow diagram of the computing component of defect detection device, an embodiment of the present disclosure.

### DETAILED DESCRIPTION

The technical solutions in the embodiments of the present invention will be clearly and completely described below, accompanied by diagrams of embodiments. Obviously, the described embodiments are only a part of the embodiments of the present invention, rather than all possible embodiments. Based on the embodiments of the present invention, all other embodiments obtained by those skilled in the art without creative work shall fall within the protection of the present invention.

The defect detection device of the embodiment of the present disclosure can inspect the object in all directions and from multiple angles to find out whether the object has defects. It can be used for defect detection of various products produced by manufacturing firms, and it can also be used for system integrators to detect defects for procured products (such as parts), and can also be used in other scenarios. The present disclosure does not limit the range of application of the defect detection device.

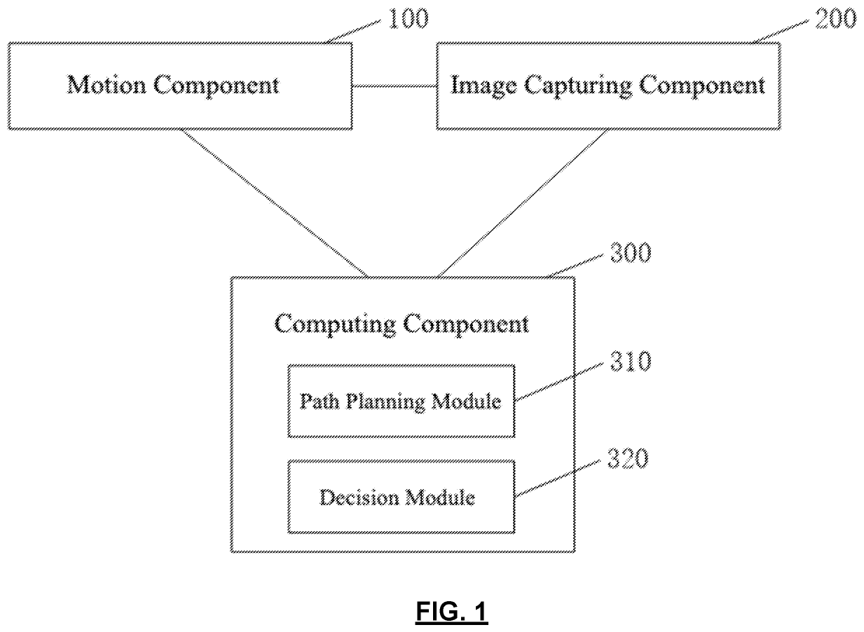

FIG. 1 shows a system diagram of a defect detection device according to an embodiment of the present disclosure. As shown in FIG. 1, the said defect detection device comprises a motion component 100, an image capturing component 200, and a computing component 300. The said computing component 300 is connected to the said motion component 100 and image capturing component 200. The said motion component 100 is used for grasping and/or placing the object to be inspected, and/or moving the aforementioned image capturing component. The image capturing component 200 is used for capturing the image of the object to be inspected. The computing component 300 includes: path planning module 310: determines multiple “1st image capturing poses” of the said object to be inspected based on the said object's all possible image capturing poses and a preset “1st sampling rates”; the present disclosure does not limit the sampling method; determines the “1st defect probabilities” according to the “1st detected images” taken by the said image capturing component 200 at the “1st image capturing poses”; establishes a defect probability matrix according to the “1st defect probabilities” and the preset defect probabilities of all other possible image capturing poses, excluding the “1st image capturing poses” with imaged already captured; partition the probability matrix into multiple submatrices, and determines the “2nd defect probabilities” of the partitioned area that each submatrix corresponds to; decision module 320: sets the maximum value of the “2nd defect probabilities” as the “3rd defect probability”; when the “3rd defect probability” is greater than or equal to the “defect probability threshold”, the object to be inspected is judged to be defective, otherwise not defective.

According to the embodiments of the present disclosure, it is possible to use the path planning module of the computing component to determine multiple image capturing poses of the object to be inspected object, according to all possible image positions and sampling rates; then use the motion component to grasp and/or place the said object, and/or adjust the image capturing component, to obtain multiple images of the said object; based on these detected images, the path planning module determines the defect probabilities of multiple image capturing poses and establishes a probability matrix, then determines the defect probabilities of each partitioned area; determines the maximum of these partitioned areas' defect probabilities through the decision module of the computing component, and determines the result of defect detection of the said object. This defect detection method sets image capturing poses based on all possible image capturing poses and the sampling rate, and uses the correlation of the image capturing poses to determine the detection result, thereby improving both efficiency and accuracy of detection, and reduce false rejection and false acceptance.

In another embodiment, the motion component 100 may include a robot or a manipulator, which can grasp, place (for example, move or rotate), unload, and adjust the image capturing component, for example, by changing the image capturing pose or the image capturing angle. For this embodiment, the robot arm (for example, a 6-axis robot arm, a SCARA robot arm, or a delta robot arm) has multiple degrees of freedom, for example three degrees of freedom, which allows it to place the object to be inspected into multiple positions and make it face different angles. Those skilled in the art can determine the number of degrees of freedom of the robot or manipulator based on the requirements of the degrees of freedom of the object to be inspected. The present disclosure does not limit the choice over the degrees of freedom.

In another embodiment, the motion component 100 has position repeatability, that is, the movement poses of the motion component has repeatability. The repeatability of the movement poses implies that the position of the motion component grasping the object to be inspected is repeatable, and motion component's adjustment of image capturing component's pose and angle is also repeatable, thereby making the imaging poses repeatable, increasing the accuracy of image capturing.

In another embodiment, the end of the robot or manipulator is a gripper and/or the image capturing component. When the end of the robot or manipulator is a gripper, the robot or manipulator can clamp or pick up the object to be inspected, and place the object in front of the image capturing component at multiple angles for image capturing; when the end is the image capturing component, the robot or manipulator can place the image capturing component at multiple angles in front of the object to be inspected for image capturing.

For example, the motion component may include two manipulators. One manipulator has a gripper at the end that can grasp the object to be inspected, and the other manipulator has an image capturing component at the end. The two manipulators can move relative to each other and form multiple angles, and by using “hand-eye calibration,” the two can capture images of the said object from all possible angles.

It should be understood that those skilled in the art can choose the appropriate robot or manipulator to suit their need. The present disclosure does not limit their choices.

In another embodiment, the image capturing component 200 may include a camera and a light source, and may capture images of the object to be inspected. The camera may be a monochrome or a colored camera, and the light source can illuminate during image capturing, so that the image capturing component can capture clear images. Choosing the light source involves considering its shape, wavelength, brightness, and other factors. Those skilled in the art can select a suitable light source according to the characteristics of the object to be detected, such as reflection, transparency, color, material, geometric shape, and other conditions. The present disclosure does not limit the camera and light source used when capturing images. In addition, the image capturing component may also include a lens, and those skilled in the art can determine whether a lens is required or the specific configuration of the lens, and the present disclosure does not limit their choices.

In another embodiment, the image capturing component 200 may also include a sensor capable of observing the object to be inspected, such as multi-spectral sensor or three-dimensional sensor, and those skilled in the art can choose a suitable sensor based on the said object's reflection, transparency, color, material, geometric shape, and other conditions. The present disclosure does not limit the sensor used when capturing images.

In another embodiment, the said computing component 300 may be a processor or a single-chip microcomputer. The processor may be a general purpose processor, such as a CPU (Central Processing Unit), or an artificial intelligence processor (IPU), for example one of or a combination of the following: GPU (Graphics Processing Unit), NPU (Neural-Network Processing Unit), DSP (Digital Signal Process), FPGA (Field Programmable Gate Array), or ASIC (Application Specific Integrated Circuit). The present disclosure does not limit the types of processors.

In another embodiment, the path planning module 310, a part of the computing component 300, determines all available image capturing poses of the object to be inspected, according to the preset imaging resolution and the geometric shape of the object to be inspected; determines the image capturing angle of each possible image capturing pose. The same type of object to be inspected will have exactly the same possible image capturing poses and the image capturing angle at each pose.

In another embodiment, the imaging resolution can be determined in the following way: first, given the requirements of optical image acquisition and the probability of false acceptance of a single image r_{b}, determine the minimum resolution res^{o}. The minimum resolution res^{o} can express the maximum sample interval for consecutive imaging when the probability of false acceptance for a single image is lower than r_{b}. For example, for the one-dimensional image capturing pose X:x, the minimum resolution is res^{o}=min (Δx). Among which, Δx is the Euclidean distance between image capturing poses in direction x; for two-dimensional image capturing pose X:(x,y), the minimum resolution is res^{o}=min(Δx,Δy), where Δx represents the Euclidean distance between adjacent image capturing poses in the direction x, and Δy represents the Euclidean distance between adjacent image capturing poses in the direction y; after determining the minimum resolution res^{o}, the imaging resolution res can be determined by using the preset image safety factor m and minimum resolution res^{o} and equation (1):

$$res = \frac{{res}^{o}}{m} \qquad ( 1 )$$

Within the equation, the value of m can be set as required, for example, m=2. The larger the value of m, the higher the imaging resolution and the lower the risk of false rejection and false acceptance. The present disclosure does not limit the specific value of m.

In another embodiment, after the imaging resolution is determined, the method determines all available image capturing poses of the object to be inspected, according to the preset imaging resolution and the geometric shape of the object to be inspected; determines the image capturing angle of each possible image capturing pose based on preset angular resolution.

For example, when the image capturing of the object to be inspected is a rectangular plane, the rectangular plane can be divided into multiple smaller rectangles of equal size according to the imaging resolution, with the vertex of the smaller rectangles are set as the possible image capturing poses. For each image capturing pose, determine multiple image capturing angles so as to capture images from multiple angles. Another example is when the surface of the object to be inspected is curved and the image capturing poses fall on the curved surface. The method can flatten the curved surface into a plane and use the method similar to that for the rectangular plane to determine the possible image capturing poses, and determine the multiple image capturing angles for each pose based on the angular resolution; when the surface of the object to be inspected has an inner hole and the image capturing poses fall outside the inner hole, the inner hole's surface can be regarded as one-dimensional, that is, a line segment along the direction of the inner hole. Use the imaging resolution to determine the possible image capturing poses, which divide the line segment along the direction of the hole into multiple smaller line segments.

In another embodiment, the geometric shape of the detection object means that it contains multiple surfaces of different shapes for image capturing. For example, a conic object has a flat circular base and a curved lateral side. Those skilled in the art can determine the image capturing poses of different surfaces according to geometric shape of the object to be inspected. The present disclosure does not limit the choices.

In another embodiment, the path planning module determines multiple “1st image capturing poses” of the object to be inspected. These poses are set according to all possible image capturing poses of the test object and a preset “1st sampling rate”; The “1st sampling ratio” is r₁ E [0, 1]. The smaller r₁ is, the number of the “1st imaging poses” selected from all possible image capturing pose will be fewer, and time taken for capturing images will be reduced. For example, if there are 1000 possible image capturing poses, when r₁ is 0.3, the number of “1st image capturing poses” is 300, and when r₁ is 0.5, the number of “1st image capturing poses” is 500. Those skilled in the art can set the value of the “1st sampling rate” according to actual requirements, and the present disclosure does not limit the choices.

In another embodiment, the same “1st sampling rate” does not mean the same method of “1st sampling.” However, if the objects to be inspected belong to the same category, then they will all have the same “1st sampling rate” and the same “1st sampling” method, meaning objects from the same category will have exactly the same possible image capturing poses and the “1st image capturing poses.” Those skilled in the art can set a specific “1st sampling method” according to actual needs, and the present disclosure does not limit this.

In another embodiment, after determining a set of “1st image capturing poses,” the path planning module 310 obtains a “1st detected image” of each “1st image capturing pose” by using the image capturing component, and determines the “1st defect probabilities” at each “image capturing pose” by using the “1st detected images.” There are many ways to determine the “1st defect probabilities” from the “1st detected images,” For example, a method can compare the “1st detected images” to preset non-defective images to analyze and calculate the “1st defect probabilities,” another can feed the “1st detected images” to a deep learning network/system to determine the “1st defect probabilities”, and other methods are possible. The present disclosure does not limit the specific method for determining the “1st defect probabilities.”

In another embodiment, after determining the set of “1st image capturing poses,” the path planning module 310 obtains at least one “1st detected image” from each “1st image capturing pose” based on each pose's image capturing angle, and determine the “1st defect probability” of each “1st image capturing pose” according to at least one of the said “1st detected images.” That is to say, it can capture images from each “1st image capturing pose” from at least one image capturing angle, and determine the “1st defect probabilities” from at least one “1st detected image.” This method improves the accuracy of the “1st defect probabilities” at the “1st image capturing poses.”

In another embodiment, after determining the “1st defect probability” at each “1st image capturing pose”. the path planning module 310 establishes a probability matrix based on all “1st defect probabilities” and the preset defect probabilities of all possible image capturing poses, excluding the “1st image capturing poses.” In other words, the probability matrix includes the probability corresponding to all available image capturing poses, where the values at the “1st image capturing poses” are the “1st defect probabilities,” while the values for other poses are the preset defect probability, for example set at 0.5.

In another embodiment, the path planning module 310 splits the probability matrix into multiple submatrices according to preset dimensions for each submatrix, and determines the “2nd defect probabilities” of the partitioned area that each submatrix corresponds to.

Among them, the size of the submatrix can be determined according to the average maximum sample interval for consecutive imaging capable of observing defects and the preset imaging resolution res. For example, the size of the submatrix q=the average maximum sample interval for consecutive imaging capable of observing defects/the imaging resolution, where q is a positive integer. When the size of the submatrix q=3, the submatrix is a 3*3 matrix.

In another embodiment, the probability matrix can be split into multiple submatrices according to the preset dimension of the submatrices. Submatrices may be overlapping or otherwise, but the sum of all submatrices must cover all of the said probability matrix. Whether the submatrices overlap can be decided based on the actual need; then, based on the multiple probability values in each submatrix, the “2nd defect probabilities” P_{R} of the partitioned area corresponding to each submatrix are determined. There are many ways to determine the “2nd defect probabilities” P_{R}. For example, the maximum of all values in the probability submatrix can be set as P_{R}, or, P_{R} can be determined based on the maximum of all values in the probability submatrix and at least one probability adjacent to the maximum value; or P_{R} can be set as the weighted average of all values in the probability submatrix; or P_{R} can be determined by a neural network or other means. The present disclosure does not limit the exact way.

In another embodiment, the “2nd defect probabilities” P_{R} of the partitioned area that each submatrix corresponds can be determined by convolution, that is, the “2nd defect probabilities” P_{R} are determined by using convolution on all values of the probability submatrix. For this method, the parameters of the convolution kernel may be a probability distribution, such as a Gaussian distribution, and those skilled in the art can select an appropriate probability distribution according to the actual need, and the present disclosure does not limit the choices.

In another embodiment, when the parameters of the convolution kernel are Gaussian, the “2nd defect probabilities” P_{R} of any submatrix can be determined by the following equation (2):

P_{R}=W_{gauss}*P (2)

In which, W_{gauss} represents the Gaussian distribution, and P represents any one submatrix.

For example, when the possible image capturing poses are one-dimensional, the “2nd defect probability” is P_{R}=Σᵢ₌₀ⁿWᵢPᵢ, where Pᵢ is the values in the probability submatrix, i represents the position of Pᵢ in the submatrix, and Wᵢ represents the Pₖ parameter of the convolution kernel corresponding to Pᵢ; when the possible image capturing poses are two-dimensional, the “2nd defect probability” is P_{R}=Σᵢ₌₀ⁿΣⱼ₌₀ⁿW_{i,j}P_{i,j}, where P_{i,j} are the values in the probability submatrix, (i, j) represents the position of P_{i,j} in the submatrix, and W_{i,j} represents the Pₖ parameter of the convolution kernel corresponding to P_{i,j}; in another embodiment, after the “2nd defect probabilities” are determined, decision module 320 of the computing component sets the maximum value of all “2nd defect probabilities” as the “3rd defect probability”; when the “3rd defect probability” is greater than or equal to the “defect probability threshold”, the object to be inspected is judged to be defective, otherwise not defective.

In this embodiment, the defect probability threshold can be set according to actual need. For example, the defect probability threshold can be set to any value between 0.75 and 0.9 (for example 0.8). Those skilled in the art can set the defect probability threshold according to the actual need, and the present disclosure does not limit this.

In another embodiment, when all possible image capturing poses of the object to be inspected include multiple levels, the levels can be arranged from the lowest to the highest, and the maximum value of the defect probabilities at each level chosen as the input for the next level, and this process is repeated until the overall defect probability is determined. For example, for an object to be inspected that has multiple surfaces for image capturing, it can pick the maximum of the probabilities of the partitioned areas from each surface, and use this maximum as the defect probability for each surface, and then select the maximum of the defect probabilities of all surfaces and use this maximum as the overall defect probability for the said object; then compare the overall defect probability to the defect probability threshold. When the overall defect probability is greater than or equal to the threshold, the object is determined to be defective, otherwise not defect.

In another embodiment, the path planning module may be used for: determine whether each “2nd defect probability” satisfies the confidence criterion, where the said confidence criterion is that if the “2nd defect probability” is less than or equal to a preset “1st confidence threshold,” or, the “2nd defect probability” is greater than or equal to a preset “2nd confidence threshold,” and where the said “1st confidence threshold” is less than the “2nd confidence threshold”; when each “2nd defect probability” satisfies the confidence criterion, go straight into the decision module to determine defects; when there exists at least one “2nd defect probability” that does not satisfy the confidence criterion, in the partitioned area that corresponds to the “2nd defect probability” which does not satisfy the confidence criterion, determine the “2nd image capturing pose” according to a preset “2nd sampling rate,” determine the “4th defect probability” of each “2nd image capturing pose” according to the “2nd detected image” at each pose; in the submatrix that corresponds to the said partitioned area, replace the preset defect probabilities with the “4th defect probabilities,” to re-determine the “2nd defect probabilities” of this area; repeat the decision process for each “2nd defect probability,” until each “2nd defect probability” satisfies the confidence criterion.

For the preset “1st confidence threshold” P_{NG,min} and “2nd confidence threshold” P_{NG,max}, those skilled in the art can set their values according to actual needs, and the present disclosure does not limit the choices.

In another embodiment, the “1st confidence threshold” P_{NG,min} is 0.5ΔP, and the “2nd confidence threshold” P_{NG,max} is 0.5+ΔP, where 0<ΔP<0.5. For example, when ΔP=0.2, the “1st confidence threshold” is 0.3 and the “2nd confidence threshold” is 0.7.

In another embodiment, after determining the “2nd defect probability” of each partitioned area, the method determines whether each “2nd defect probability” satisfies the confidence criterion. The confidence criterion is that the “2nd defect probability” is less than or equal to the preset “1st confidence threshold” P_{NG,min} or the “2nd defect probability” is greater than or equal to the preset “2nd confidence threshold” P_{NG,max}. If the “2nd defect probability” P_{R}≥P_{NG,max} or P_{R}≤p_{NG,min}, judge that the “2nd defect probability” satisfies the confidence criterion; if P_{NG,min}<P_{R}<P_{NG,max}, judge that the “2nd defect probability” does not satisfy the confidence criterion.

In another embodiment, when the each “2nd defect probability” satisfies the confidence criterion, the method goes straight to the decision module to determine defects, without capturing more images of the object to be inspected.

In another embodiment, when there exists one or more “2nd defect probability” that does not satisfy the confidence criterion, the method sets the “2nd image capturing poses” in the partitioned areas where those “2nd defect probabilities” do not satisfy the confidence criterion, according to the preset “2nd sampling rate.” The said “2nd sampling rate” is r₂∈[0,1] where r₂>r₁.

In another embodiment, the “2nd image capturing poses” may not include the “1st image capturing poses,” meaning that “2nd image capturing poses” differ from the “1st image capturing poses.” This means that images are not captured twice in the same and will increase efficiency.

After the “2nd image capturing poses” are set, determine the “4th defect probability” of each “2nd image capturing pose” according to the “2nd detected image” captured by the image capturing component at each pose. There are many ways to determine the “4th defect probabilities” from the “2nd detected images”. For example, a method can compare the “2nd detected images” to preset non-defective images to analyze and calculate the “4th defect probabilities,” another can load the “2nd detected images” to a deep learning network/system to determine the “4th defect probabilities”, and other methods are possible. The present disclosure does not limit the specific method for determining the “4th defect probabilities.”

In another embodiment, the method obtains at least one “2nd detected image” from each “2nd image capturing pose” based on each pose's image capturing angle, and determine the “4th defect probability” of each “2nd image capturing pose” according to at least one of the said “2nd detected image.” That is to say, it can capture images from each “2nd image capturing pose” from at least one image capturing angle, and determine the “4th defect probabilities” from at least one “2nd detected image.” This method improves the accuracy of the “4th defect probabilities” at the “2nd image capturing poses.”

After the “4th defect probabilities” are determined, use the “4th defect probabilities” to replace the matching preset defect probabilities in the submatrix corresponding to the partitioned areas, to re-determine the “2nd defect probabilities” of the partitioned areas; then repeat determining whether each “2nd defect probability” satisfies the confidence criterion, until each “2nd defect probability” satisfies the confidence criterion.

In this embodiment, when the “2nd defect probability” does not satisfy the confidence criterion, the “2nd imaging pose” needs to be determined, in order to re-determine the “2nd defect probability” of the partitioned area until each “2nd defect probability” satisfies the confidence criterion, so that the “2nd defect probability” of each partitioned area is credible. This process allows the “2nd image capturing pose” to change dynamically based on the specific values of the “2nd defect probabilities,” achieving dynamic planning of the image capturing path and pose, and improving the relevance of image capturing poses. At the same time, this process goes into the decision module only when each “2nd defect probability” satisfies the confidence criterion. so as to improve the accuracy of defect judgment.

In another embodiment, the path planning module includes a neural network, such as a convolutional neural network or a decision network, to improve the efficiency of data processing and/or image processing.

In another embodiment, the method uses a decision network to determine the “1st defect probability” and/or the said “4th defect probability,” specifically: feed the “1st detection images” and/or the “2nd detection images” into the decision network for computing, to obtain the “1st defect probabilities” and/or the “4th defect probabilities”.

The decision network can be a deep learning network, which judge the images captured by the image capturing component. The input can be image pixels or 3D voxels, and the output is defect probability of either the input images or 3D data.

In another embodiment, the decision network needs to be trained before it is used to improve the accuracy of the result. It is possible to use the images in a training set (each pixel of the images has been marked OK/NG (including defect types) to train the decision network through supervised or unsupervised learning, so that the decision network can automatically learn the features of the images from the training set, without the need for manual writing of features.

In another embodiment manner, when the “1st defect probabilities” and/or the “4th defect probabilities” are determined by the decision network, the “1st detection images” and/or the “2nd detection images” are fed to the decision network, and the decision network can preprocess the “1st detected images” and “2nd detected images” to enhance the recognizability of defects, and then each pixel in the “1st detected image” and/or the “2nd detected image” is judged, with the result of each pixel is either OK or NG. If the result is NG, the defect type of NG can be further judged; then the result of each pixel of the “1st detected images” and/or the “2nd detected image” is normalized (Softmax) to obtain the “1st defect probabilities” and/or “4th defect probabilities.”

In this embodiment, by determining the “1st defect probabilities” and/or the “4th defect probabilities” through the decision network, it improves the speed and accuracy in calculating the “1st defect probabilities” and/or the “4th defect probabilities.”

In another embodiment, the “2nd defect probability” may be determined through a convolutional neural network, specifically: determine the convolution kernel and stride length of the convolutional neural network according to a preset dimension of the submatrix; use the said convolutional neural network to perform a convolution on the said probability matrix, based on the said convolution kernel and stride length, to obtain the “2nd defect probabilities” of each partitioned area of the object to be inspected. The parameters of the convolutional neural network can be determined according to a probability distribution, such as a Gaussian distribution, and those skilled in the art can select a suitable probability distribution according to actual needs. The present disclosure does not limit the specific values of the parameters of the convolutional neural network. In another embodiment, the probability distribution is preferably a Gaussian distribution.

For example, when the dimension of the submatrix is q=3, the convolution kernel of the convolutional neural network can be set to be 3*3, and the stride length is set to a positive integer less than or equal to q, for example, 1, 2 or 3 (or another value that best suits the need); then feed the probability matrix into the convolutional neural network for convolution. During the convolution, the submatrix where the convolution kernel is located corresponds to a partitioned area of the object to be inspected. This process obtains the “2nd defect probability” of each partitioned area of the object to be inspected. The number of partitioned areas is related to the convolution kernel and the stride length.

This embodiment uses the convolution neural network to determine the “2nd defect probabilities,” thereby improving the speed and accuracy in calculating the “2nd defect probabilities.”

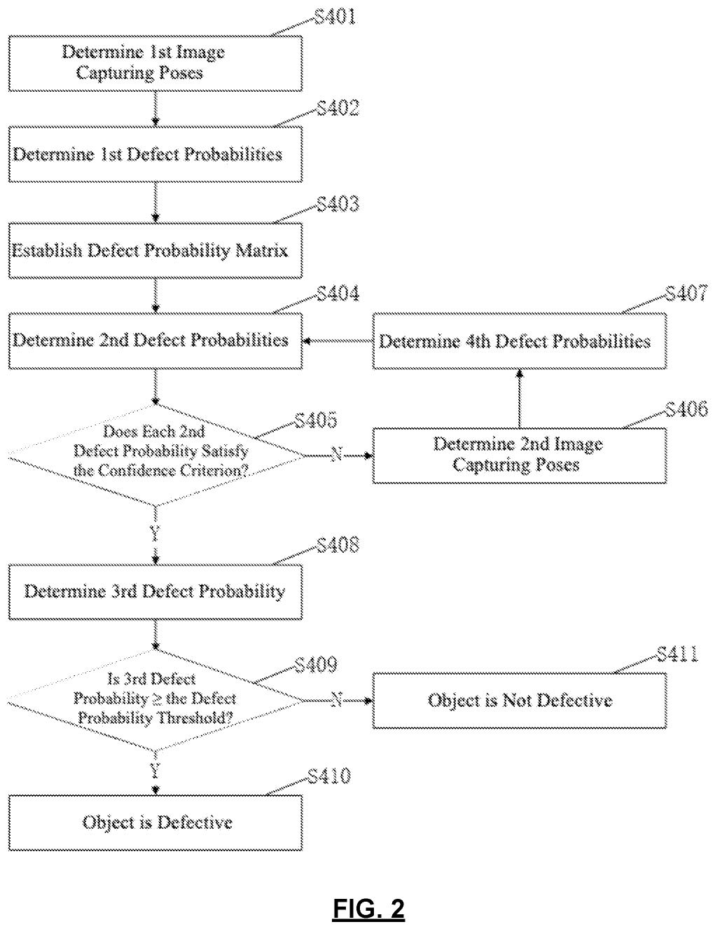

FIG. 2 shows a flow diagram of the computing component of defect detection device, an embodiment of the present disclosure. As shown in FIG. 2, after the computing component determines all possible image capturing poses according to the imaging resolution and the geometric shape of the object to be inspected, step S401 can determine multiple “1st image capturing poses” from all possible image capturing poses based on the preset “1st sampling rate,” and step S402 determines the “1st defect probability” of each “1st image capturing pose” according to the “1st detected images” captured by the image capturing component at each “1st image capturing pose,”

Then, in step S403, a probability matrix is established, according to the “1st defect probabilities” and the preset defect probability of all possible image capturing poses excluding the “1st image capturing poses.” Step S404 splits the probability matrix into multiple 3×3 submatrices, according to the preset submatrix size 3, and determines “2nd defect probability” of the partitioned area that corresponds to each submatrix; after the “2nd defect probabilities” are determined, step S405 determines whether each “2nd defect probability” satisfies the confidence criterion, where the confidence criterion is that the “2nd defect probability” is less than or equal to 0.3, the “1st probability threshold,” or the “2nd defect probability” is greater than or equal to 0.7, the “2nd probability threshold”; when at least one “2nd defect probability” does not satisfy the confidence criterion, Step S406 sets the “2nd image capturing poses” according to a preset “2nd sampling rate,” in the partitioned areas that correspond to those “2nd defect probabilities” which do not satisfy the confidence criterion, Step S407 determines the “4th defect probabilities” at each “2nd image capturing pose” according to the “2nd detected image” captured by the image capturing component at each “2nd image capturing pose,” and use the “4th defect probabilities” to replace the preset defect probability in the submatrix that corresponding to the partitioned area; then step S404 re-determines the “2nd defect probabilities” of the partitioned areas; when each “2nd defect probability” satisfies the confidence criterion, step S408 sets the maximum value of all the “2nd defect probabilities” as the “3rd defect probability” of the object to be inspected; step S409 determines whether the “3rd defect probability” is greater than or equal to 0.8, the defect probability threshold; when the “3rd defect probability” is greater than or equal to 0.8, the defect probability threshold value, step S410 judges that the object is defective; otherwise, step S411 judge the object to be not defective.

According to the embodiments of the present disclosure, the defect detection device can determine all the available image capturing poses of the object to be inspected, according to the preset imaging resolution and the geometric shape of the object, so that the computing component can achieve the functions of hardware customization, which was necessary for different shapes of the object to be inspected, so the defect detection device can suit the needs of a variety of objects.

According to the embodiments of the present disclosure, it is possible to use the path planning module of the computing component to determine multiple image capturing poses of the object to be inspected, based on all possible image capturing poses of the object and sampling rates, and then use the motion component to grasp and/or place the object, and/or adjust the image capturing component, and capture images using the image capturing component to obtain images of the object. Using the multiple detected images, the path planning module determines the defect probabilities of the multiple image capturing poses, and then determine the defect probabilities of multiple partitioned areas, and then judge whether the defect probability of each partitioned area satisfies the confidence criterion. When the defect probability of a partitioned area does not satisfy the confidence criterion, it is necessary to determine the new image capturing poses of the partitioned area, and then re-determine the “2nd defect probability” of the partitioned area. When the defect probability of each partitioned area satisfies the confidence criterion, the method uses the decision module of the computing component to determine the maximum value of the defect probabilities of multiple partitioned areas, and uses this maximum value to determine the result of defect detection of the object, thereby achieve the dynamic planning of the image capturing path and poses during defect detection, and use the correlation of the image capturing poses to determine the detection results. This method not only effectively identifies the random defects and the complex material surface of the object to be inspected, but also improves the efficiency and accuracy of defect detection, and reduce false rejection and false acceptance.

In another aspect of the present disclosure, a defect detection method is also provided, and the method includes: path planning: determines multiple “1st image capturing poses” of the object to be inspected. These poses are set according to all possible image capturing poses of the test object and a preset “1st sampling rate”; determines the “1st defect probabilities” at each “1st image capturing pose,” based on theist “detected images” captured at the said each “1st image capturing pose”; establishes a probability matrix according to the said “1st defect probabilities,” as well as preset defect probabilities for all other possible image capturing poses, excluding the ones with images captured; splits the probability matrix into multiple submatrices according to preset dimensions for each submatrix, and determines the “2nd defect probabilities” of the area that each submatrix corresponds to; decision step: sets the maximum value of the “2nd defect probabilities” as the “3rd defect probability”; when the “3rd defect probability” is greater than or equal to the “defect probability threshold”, the object to be inspected is judged to be defective, otherwise not defective.

In another embodiment, the path planning step further comprises: determining whether each “2nd defect probability” satisfies the confidence criterion, where the said confidence criterion is that if the “2nd defect probability” is less than or equal to a preset “1st confidence threshold,” or, the “2nd defect probability” is greater than or equal to a preset “2nd confidence threshold,” and where the said “1st confidence threshold” is less than the “2nd confidence threshold”; when each “2nd defect probability” satisfies the confidence criterion, going straight into the decision step; when there exists at least one “2nd defect probability” that does not satisfy the confidence criterion, in the partitioned areas that correspond to those “2nd defect probabilities” which do not satisfy the confidence criterion, setting “2nd image capturing poses” according to a preset “2nd sampling rate,” determining the “4th defect probability” of each “2nd image capturing pose” according to the “2nd detected image” at each pose; in the submatrix that corresponds to the said partitioned area, replacing the preset defect probabilities with the “4th defect probabilities,” to re-determine the “2nd defect probabilities” of this area; repeat the decision process for each “2nd defect probability,” until each “2nd defect probability” satisfies the confidence criterion.

According to the embodiments of the present disclosure, it is possible to achieve dynamic planning of the image capturing path and poses during defect detection, and use the correlation of the image capturing poses to determine the detection results. This method not only effectively identifies the random defects and the complex material surface of the object to be inspected, but also improves the efficiency and accuracy of defect detection, and reduce false rejection and false acceptance.

The above are only examples of embodiments of the present invention, and do not limit the scope of the patent protection of the present invention. Any equivalent transformation of structures and processes, made using the description and drawings of the present invention, or directly or indirectly applied to other related technical fields, are therefore also included in the scope of patent protection of the present invention.

1-13. (canceled)

14. A defect detection device for inspecting an object, comprising:
an image capturing component for capturing one or more images of the object to be inspected;
a motion component configured to grasp or manipulate the object to be inspected or the image capturing component; and
a computing device comprising one or more processors and operably connected to the motion and image capturing components, the computing device being configured to:
determine a plurality of first image capturing poses of the object to be inspected based on a set of possible image capturing poses and a sampling rate,
determine a first defect probability for each particular first image capturing pose of the first image capturing poses based on a first detected image captured by the image capturing component at the particular first image capturing pose,
establish a probability matrix based on the first defect probabilities corresponding to the plurality of first image capturing poses and preset defect probabilities for a remainder of the set of possible image capturing poses,
subdivide the probability matrix into a plurality of submatrices according to preset dimensions for each submatrix,
determine a second defect probability for each of the plurality of submatrices,
set a maximum value of the second defect probabilities as a third defect probability of the object to be inspected, and
compare the third defect probability of the object to a defect probability threshold to determine whether the object is defective,
wherein, when the third defect probability is greater than or equal to the defect probability threshold, the object to be inspected is judged to be defective, and
wherein, when the third defect probability is less than the defect probability threshold, the object to be inspected is judged to be not defective.

15. The defect detection device of claim 14, wherein the computing device is further configured to perform a confidence criterion process, the confidence criterion process comprising:
determining whether each second defect probability satisfies a confidence criterion, wherein a particular second defect probability satisfies the confidence criterion when: (i) the second defect probability is less than or equal to a first confidence threshold, or (ii) the second defect probability is greater than or equal to a second confidence threshold, the first confidence threshold being less than the second confidence threshold;
when a particular second defect probability does not satisfy the confidence criterion:
determining a partitioned area of the object corresponding to the particular second defect probability that does not satisfy the confidence criterion,
determining a second image capturing pose of the object to be inspected based on a second sampling rate, the second image capturing pose corresponding to the partitioned area,
determining a fourth defect probability for the second image capturing pose based on a second detected image captured by the image capturing component at the second image capturing pose, and
in the submatrix that corresponds to the partitioned area, replacing the preset defect probabilities with the fourth defect probabilities to obtain an updated second defect probability for the submatrix,
wherein the computing device is configured to repeat the confidence criterion process until each updated second defect probability satisfies the confidence criterion.

16. The defect detection device of claim 14, wherein determining the second defect probability for each of the plurality of submatrices comprises utilizing a convolutional neural network having a convolution kernel and stride length based on preset dimensions for each submatrix to perform a convolution operation on the probability matrix.

17. The defect detection device of claim 16, wherein the preset dimensions for each submatrix is based on an average maximum sample interval for consecutive imaging capable of observing defects and a preset imaging resolution, and parameters of the convolutional neural network are determined according to a probability distribution.

18. The defect detection device of claim 17, wherein the probability distribution comprises a Gaussian distribution.

19. The defect detection device of claim 14, wherein the second image capturing pose differs from the first imaging pose.

20. The defect detection device of claim 14, wherein the computing device is further configured to:
determine the set of possible image capturing poses of the object to be inspected based on a preset imaging resolution and a geometric shape of the object to be inspected; and
determine an image capturing angle for each of the plurality of first image capturing poses based on a preset angular resolution.

21. The defect detection device of claim 20, wherein the computing device is further configured to:
obtain at least one first detected image from each of the plurality of first image capturing poses based on the image capturing angle.

22. The defect detection device of claim 14, wherein determining the first defect probability for each particular first image capturing pose comprises feeding the first detected image into a decision network, wherein the decision network outputs the first defect probability for each particular first image capturing pose.

23. The defect detection device of claim 14, wherein the motion component comprises a robot or a manipulator, and the imaging capturing component comprises a camera and a light source.

24. The defect detection device of claim 23, wherein the end of the robot or manipulator is a gripper or the image capturing component.

25. The defect detection device of claim 14, wherein each submatrix of the plurality of submatrices overlaps with another submatrix of the plurality of submatrices.

26. A defect detection method for inspecting an object, comprising:
determining, at a computing device having one or more processors, a plurality of first image capturing poses of the object to be inspected based on a set of possible image capturing poses and a sampling rate;
determining, at the computing device, a first defect probability for each particular first image capturing pose of the first image capturing poses based on a first detected image captured by an image capturing component at the particular first image capturing pose;
establishing, at the computing device, a probability matrix based on the first defect probabilities corresponding to the plurality of first image capturing poses and preset defect probabilities for a remainder of the set of possible image capturing poses;
subdividing, at the computing device, the probability matrix into a plurality of submatrices according to preset dimensions for each submatrix;
determining, at the computing device, a second defect probability for each of the plurality of submatrices;
setting, at the computing device, a maximum value of the second defect probabilities as a third defect probability of the object to be inspected; and
comparing, at the computing device, the third defect probability of the object to a defect probability threshold to determine whether the object is defective, wherein, when the third defect probability is greater than or equal to the defect probability threshold, the object to be inspected is judged to be defective, and
wherein, when the third defect probability is less than the defect probability threshold, the object to be inspected is judged to be not defective.

27. The defect detection method of claim 26, further comprising performing, at the computing device, a confidence criterion process, the confidence criterion process comprising:
determining whether each second defect probability satisfies a confidence criterion, wherein a particular second defect probability satisfies the confidence criterion when: (i) the second defect probability is less than or equal to a first confidence threshold, or (ii) the second defect probability is greater than or equal to a second confidence threshold, the first confidence threshold being less than the second confidence threshold;
when a particular second defect probability does not satisfy the confidence criterion:
determining a partitioned area of the object corresponding to the particular second defect probability that does not satisfy the confidence criterion,
determining a second image capturing pose of the object to be inspected based on a second sampling rate, the second image capturing pose corresponding to the partitioned area,
determining a fourth defect probability for the second image capturing pose based on a second detected image captured by the image capturing component at the second image capturing pose, and
in the submatrix that corresponds to the partitioned area, replacing the preset defect probabilities with the fourth defect probabilities to obtain an updated second defect probability for the submatrix,
wherein the confidence criterion process is repeated until each updated second defect probability satisfies the confidence criterion.

28. The defect detection method of claim 26, wherein determining the second defect probability for each of the plurality of submatrices comprises utilizing a convolutional neural network having a convolution kernel and stride length based on preset dimensions for each submatrix to perform a convolution operation on the probability matrix.

29. The defect detection method of claim 28, wherein the preset dimensions for each submatrix is based on an average maximum sample interval for consecutive imaging capable of observing defects and a preset imaging resolution, and parameters of the convolutional neural network are determined according to a probability distribution.

30. The defect detection method of claim 29, wherein the probability distribution comprises a Gaussian distribution.

31. The defect detection method of claim 26, wherein the second image capturing pose differs from the first imaging pose.

32. The defect detection method of claim 26, further comprising:
determining the set of possible image capturing poses of the object to be inspected based on a preset imaging resolution and a geometric shape of the object to be inspected; and
determining an image capturing angle for each of the plurality of first image capturing poses based on a preset angular resolution.

33. The defect detection method of claim 32, further comprising:
obtaining at least one first detected image from each of the plurality of first image capturing poses based on the image capturing angle.

34. The defect detection method of claim 26, wherein determining the first defect probability for each particular first image capturing pose comprises feeding the first detected image into a decision network, wherein the decision network outputs the first defect probability for each particular first image capturing pose.

35. The defect detection method of claim 26, wherein each submatrix of the plurality of submatrices overlaps with another submatrix of the plurality of submatrices.
